(19) United States
(12) Patent Application Publication
(10) Pub. No.: US 2008/0168299 A1
(43) Pub. Date: Jul. 10, 2008

(54) Recovery Mechanism for Embedded Device

(76) Inventors: Jim Kateley, San Jose, CA (US); Patrick E. McClaughry, Sunnyvale, CA (US)

Correspondence Address: FISH & RICHARDSON P.C., PO BOX 1022, MINNEAPOLIS, MN, 55440-1022, US

(21) Appl. No.: 11/621,050

(22) Filed: Jan. 8, 2007

(51) Int. Cl. G06F 11/07

(52) U.S. Cl. 714/2

(57) ABSTRACT

A device can be recovered by detecting a recovery event in a device having read-only and read-write memory partitions; selecting a set of recovery instructions stored in the device's read-only memory partition; booting the device based on the selected set of recovery instructions; and restoring a set of operating instructions in the device's read-write memory partition based on the set of recovery instructions. Detecting a recovery event further can comprise detecting a predetermined number of consecutive unsuccessful boot operations. Alternatively, detecting a recovery event further can comprise receiving from a user a command to execute a recovery operation. Further, a value in a non-volatile memory can be set to identify the read-only partition storing the set of recovery instructions as a boot partition. Additionally, restoring a set of operating instructions further can comprise replacing the set of operating instructions with at least a portion of the set of recovery instructions.

### BACKGROUND

The present disclosure relates to embedded devices such as media processing devices, and to systems and methods for performing initialization and error recovery in media processing devices.

Media processing devices can be configured to perform playback of one or more types of media, including audio, images, video, and mixed media. The playback can be performed through one or more embedded outputs, such as speakers and a display included in the media processing device or through one or more external presentation devices coupled to the media processing device. For example, a media processing device, such as a digital video recorder, can be coupled to a television to present playback of a media stream including video and audio information, such as a movie or a television program. Alternatively, the digital video recorder can be configured to separately provide video information to a television and audio information to an audio receiver that is coupled to one or more speakers.

A wide variety of presentation devices that can be coupled to a media processing device are presently available. Further, presentation device capabilities can vary based on numerous factors, including cost, manufacturer, and intended use. For example, televisions can be configured to support one or more analog video standards, such as NTSC or PAL/SECAM. A television also can be configured to support one or more digital video standards, such as High Definition Television (HDTV) and Enhanced Definition Television (EDTV). Further, a video transmission standard can include more than one resolution. For example, HDTV supports numerous resolutions, including 480p, 720p, and 1080i, where 480p denotes a progressive scan of 480 vertical scanning lines and 1080i denotes an interlaced scan of 1,080 vertical scanning lines. Audio information also can be output in a variety of formats, such as stereo, Dolby Digital, and Dolby Digital EX.

Operation of a media processing device can be controlled through one or more instructions executed by a processor. For example, a set of operating instructions, such as an operating system, can be stored in non-volatile memory included in the media processing device. During operation of the media processing device specific instructions can be executed to control device functionality. If the set of operating instructions is stored in alterable memory, one or more of the instructions can be updated to permit the addition of new features and to allow problems with one or more existing operating instructions to be corrected. When a set of operating instructions is corrupted, however, the device must be recovered before normal operations can resume.

### SUMMARY

A media processing device, such as a media client that receives media content from one or more sources, can be configured to present output information to one or more presentation devices. Further, a media client can be configured to perform a variety of functions and operations, including formatting one or more media streams for playback. Many of these techniques and methods rely on configuring the media client to execute a set of operating instructions, such as utilities or an operating system. In order to ensure the integrity of the set of operating instructions, the present inventors recognized that it was beneficial to automatically detect a problem, such as failure of the media client to properly initialize, and to automatically restore the set of operating instructions.

The present inventors also recognized the need to recover the media client by restoring a trusted set of operating instructions. Further, the need to permit a user to instruct the media client to restore the set of operating instructions to a trusted version also is recognized. Accordingly, the techniques and apparatus described here implement algorithms for automatically detecting problems with device operation and for restoring a set of operating instructions associated with a media client.

In general, in one aspect, the techniques can be implemented to include detecting a recovery event in a device having read-only and read-write memory partitions; selecting a set of recovery instructions stored in the device's read-only memory partition; booting the device based on the selected set of recovery instructions; and restoring a set of operating instructions in the device's read-write memory partition based on the set of recovery instructions.

The techniques also can be implemented such that detecting a recovery event further comprises detecting a predetermined number of consecutive unsuccessful boot operations. Further, the techniques can be implemented such that detecting a recovery event further comprises receiving from a user a command to execute a recovery operation. Additionally, the techniques can be implemented to include setting a value in a non-volatile memory to identify the read-only partition storing the set of recovery instructions as a boot partition.

The techniques also can be implemented such that restoring a set of operating instructions further comprises replacing the set of operating instructions with at least a portion of the set of recovery instructions. Further, the techniques can be implemented such that the read-write memory partition is formatted prior to replacing the set of operating instructions. Additionally, the techniques can be implemented such that restoring a set of operating instructions further comprises downloading and installing one or more updates from a server.

The techniques also can be implemented to include booting the device based on the restored set of operating instructions. Additionally, the techniques can be implemented to include erasing at least one item of information stored on the device, wherein the at least one item of information comprises media content or configuration information.

In general, in another aspect, the techniques can be implemented as a computer program product, encoded on a computer-readable medium, operable to cause data processing apparatus to perform operations comprising detecting a recovery event in a device having read-only and read-write memory partitions; selecting a set of recovery instructions stored in the device's read-only memory partition; booting the device based on the set of recovery instructions; and restoring a set of operating instructions in the device's read-write memory partition based on the set of recovery instructions.

The techniques also can be implemented to be further operable to cause data processing apparatus to perform operations comprising detecting a predetermined number of consecutive unsuccessful boot operations. Additionally, the techniques can be implemented to be further operable to cause data processing apparatus to perform operations comprising receiving from a user a command to execute a recovery operation. Further, the techniques can be implemented to be further operable to cause data processing apparatus to perform operations comprising setting a value in a non-volatile memory to identify the read-only partition storing the set of recovery instructions as a boot partition.

The techniques also can be implemented to be further operable to cause data processing apparatus to perform operations comprising replacing the set of operating instructions with at least a portion of the set of recovery instructions. Further, the techniques can be implemented such that the read-write memory partition is formatted prior to replacing the set of operating instructions. Additionally, the techniques can be implemented to be further operable to cause data processing apparatus to perform operations comprising downloading and installing one or more updates from a server.

The techniques also can be implemented to be further operable to cause data processing apparatus to perform operations comprising booting the device based on the restored set of operating instructions. Additionally, the techniques can be implemented to be further operable to cause data processing apparatus to perform operations comprising erasing at least one item of information stored in the device, wherein the at least one item of information comprises media content or configuration information.

These general and specific techniques can be implemented using an apparatus, a method, a system, or any combination of an apparatus, methods, and systems. The details of one or more implementations are set forth in the accompanying drawings and the description below. Further features, aspects, and advantages will become apparent from the description, the drawings, and the claims.

### BRIEF DESCRIPTION OF THE DRAWINGS

FIG. 1 presents a diagram of a media processing device.

FIG. 2 presents a media system that includes a media processing device.

FIG. 3 depicts the logical organization of a storage device included in a media client.

FIG. 4 presents a flowchart for performing a boot operation in a media client.

FIG. 5 presents a flowchart for performing a boot recovery operation in a media client.

FIG. 6 describes a computer-implemented method of recovering a device.

Like reference symbols indicate like elements throughout the specification and drawings.

### DETAILED DESCRIPTION

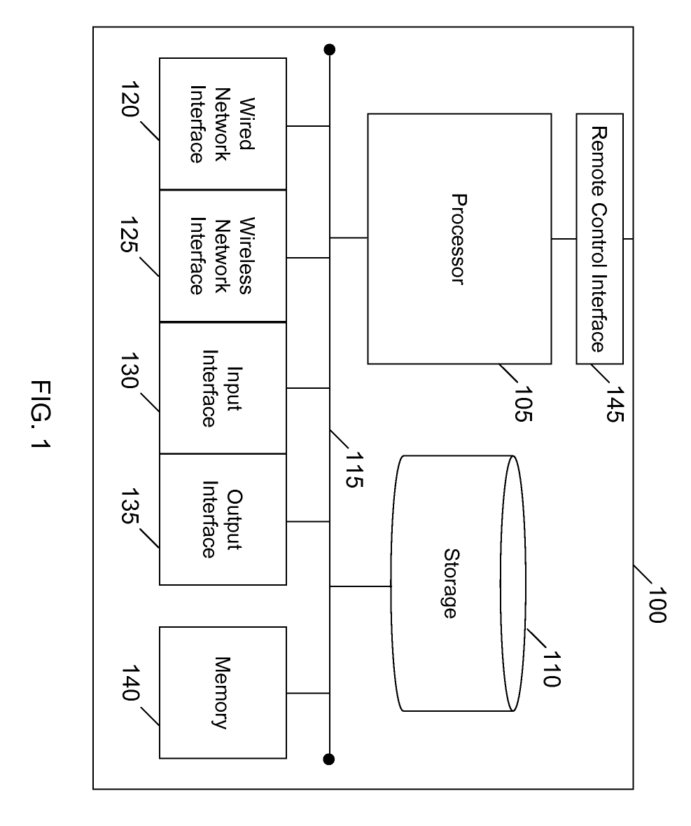

FIG. 1 presents a media client 100 that can be configured to present one or more types of media through a presentation device, including audio, video, images, or any combination thereof. The media client 100 includes a processor 105 configured to control the operation of the media client 100. For example, the processor 105 can control communications with one or more media servers to receive media for playback. The media can be received through push and/or pull operations, including through downloading and streaming. The processor 105 also can be configured to generate output signals for presentation, such as one or more streams representing media content or an interface for interacting with a user.

The media client 100 also includes a storage device 110 that can be configured to store information including media, configuration data, and operating instructions. The storage device 110 can be any type of non-volatile storage, including a hard disk device or a solid-state drive. For example, media received from an external media server can be stored on the storage device 110. The received media thus can be locally accessed and processed. Further, configuration information, such as the resolution of a coupled display device or information identifying an associated media server, can be stored on the storage device 110. Additionally, the storage device 110 can include one or more sets of operating instructions that can be executed by the processor 105 to control operation of the media client 100. In an implementation, the storage device 110 further can be divided into a plurality of partitions, wherein each partition can be utilized to store one or more types of information. Additionally, each partition can have one or more access control provisions.

A communication bus 115 couples the processor 105 to the other components and interfaces included in the media client 100. The communication bus 115 can be configured to permit unidirectional and/or bidirectional communication between the components and interfaces. For example, the processor 105 can retrieve information from and transmit information to the storage device 110 over the communication bus 115. In an implementation, the communication bus 115 can be comprised of a plurality of busses, each of which couples at least one component or interface of the media client 100 with another component or interface.

The media client 100 also includes a plurality of input and output interfaces for communicating with other devices, including media servers and presentation devices. A wired network interface 120 and a wireless network interface 125 each can be configured to permit the media client 100 to transmit and receive information over a network, such as a local area network (LAN) or the Internet. Additionally, an input interface 130 can be configured to receive input from another device through a direct connection, such as a USB or an IEEE 1394 connection.

Further, an output interface 135 can be configured to couple the media client 100 to one or more external devices, including a television, a monitor, an audio receiver, and one or more speakers. For example, the output interface 135 can include one or more of an optical audio interface, an RCA connector interface, a component video interface, and a High-Definition Multimedia Interface (HDMI). The output interface 135 also can be configured to provide one signal, such as an audio stream, to a first device and another signal, such as a video stream, to a second device. Further, a non-volatile memory 140, such as a read-only memory (ROM) also can be included in the media client 100. The non-volatile memory 140 can be used to store configuration data, additional instructions, such as one or more operating instructions, and values, such as one or more flags and counters. In an implementation, a random access memory (RAM) also can be included in the media client 100.

Additionally, the media client 100 can include a remote control interface 145 that can be configured to receive commands from one or more remote control devices (not pictured). The remote control interface 145 can receive the commands through wireless signals, such as infrared and radio frequency signals. The received commands can be utilized, such as by the processor 105, to control media playback or to configure the media client 100. In an implementation, the media client 100 can be configured to receive commands from a user through a touch screen interface. The media client 100 also can be configured to receive commands through one or more other input devices, including a keyboard, a keypad, a touch pad, a voice command system, and a mouse.

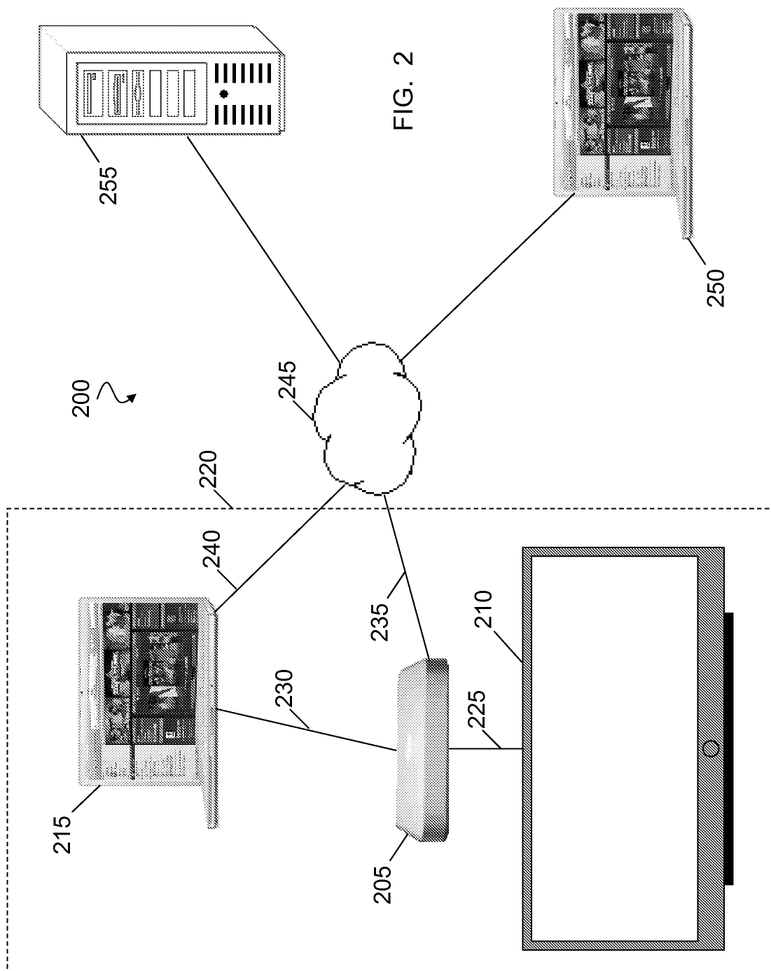

FIG. 2 presents a media system 200 that includes a media client 100. The media system 200 includes a host location 220, such as a home or office, in which the media client 100 is installed. The host location 220 also can include a local media server 215 and a presentation device, such as a monitor 210. The monitor 210 can be coupled to the media client 100 through a media connector 225, such that video and/or audio information output by the media client 100 can be presented through the monitor 210. Further, the media client 100 can be coupled to the local media server 215 through a local connection 230, such as a wired network connection, a wireless network connection, or a direct connection. As such, the media client 100 can receive media content from the local media server 215. The local media server 215 can be any computing device, including a personal computer, a server, a palm top computer, or a media device capable of storing and/or playing back media content.

Further, the media client 100 and the local media server 215 can include network connections 235 and 240 respectively, which provide access to a network 245, such as the Internet. In an implementation, the media client 100 can communicate with a remote media server 250 and/or a media store 255 over the network 245. For example, a connection can be established between the media client 100 and the remote media server 250. The connection can be secure or unsecure. Thereafter, the media client 100 can receive media content from the remote media server 250, such as by streaming or downloading.

Similarly, the media client 100 can be configured to receive media content from a media store 255. For example, upon establishing a connection, the media client 100 can request a list of available media content from the media store 255. The list of available media content can include free content, such as trailers and pod casts, and for-purchase content, such as movies, television programs, and music. Additionally, the media client 100 can be configured to communicate with the media store 255 to validate media content, such as by verifying digital rights management information.

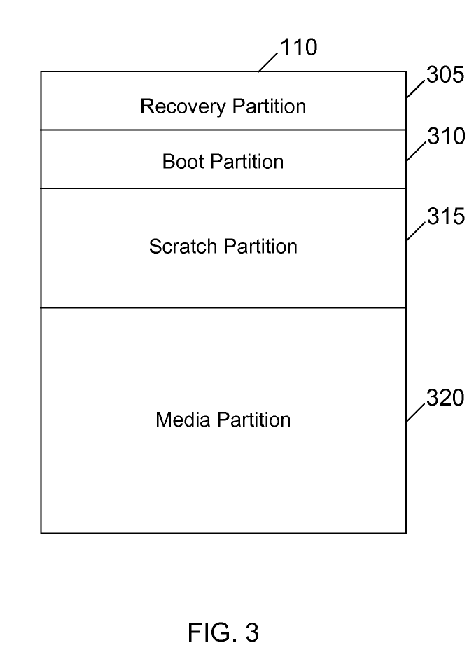

FIG. 3 depicts the logical organization of the storage device 110 included in the media client 100. The storage device 110 can be configured to include a plurality of partitions, each of which can have one or more independent permissions and access controls. Further, the size of each partition can be separately determined. A recovery partition 305 can be configured to store a set of operating instructions that can be used to recover the media client 100 in the event of an error or malfunction, such as if one or more operating instructions are corrupted.

The set of operating instructions stored in the recovery partition 305 can be a trusted set of operating instructions that, when executed, cause the media client 100 to function in a known manner. In an implementation, the set of operating instructions stored in the recovery partition 305 can provide at least a core suite of functions and operations, and can comprise a complete set of operating instructions. Additionally, an access control associated with the recovery partition 305 can be set to read-only to prevent the set of operating instructions contained therein from being overwritten or modified. For example, the recovery partition 305 can be made read-only after it is programmed, such as by the manufacturer. Because the recovery partition 305 is read-only and thus will not require space to store additional information, an exact partition size can be determined.

The storage device 110 also can include a boot partition 310. The boot partition 310 can be configured to store the set of operating instructions used to control the media client 100 during operation. In an implementation, a common set of operating instructions can be contained in the recovery partition 305 and the boot partition 310 after initial programming of the media client 100. Further, an access control associated with the boot partition 310 can be set to read-only to prevent the set of operating instructions contained therein from being overwritten or modified. Alternatively, the boot partition 310 can be configured to permit at least some write access, such as to permit the set of operating instructions to be updated. Thus, the set of operating instructions included in the boot partition 310 can be modified to include additional features and corrections. Further, the set of operating instructions included in the boot partition 310 can be overwritten during a recovery procedure.

A scratch partition 315 can be used to store data associated with the media client 100, such as one or more preferences, settings, and configurations. An access control associated with the scratch partition 315 can be set to read-write to permit data to be stored in, modified, and deleted from the scratch partition 315 during operation of the media client 100. The storage device 110 also can include a media partition 320 for storing media content that can be played back by the media client 100. For example, media content downloaded from a media server can be stored in the media partition 320 and played back at a time specified by a user. Additionally, the media partition 320 can be used to buffer media content that is streamed to the media client 100 from a media server. An access control associated with the media partition 320 can be set to read-write to permit data to be stored in, modified, and deleted from the media partition 320 during operation of the media client 100.

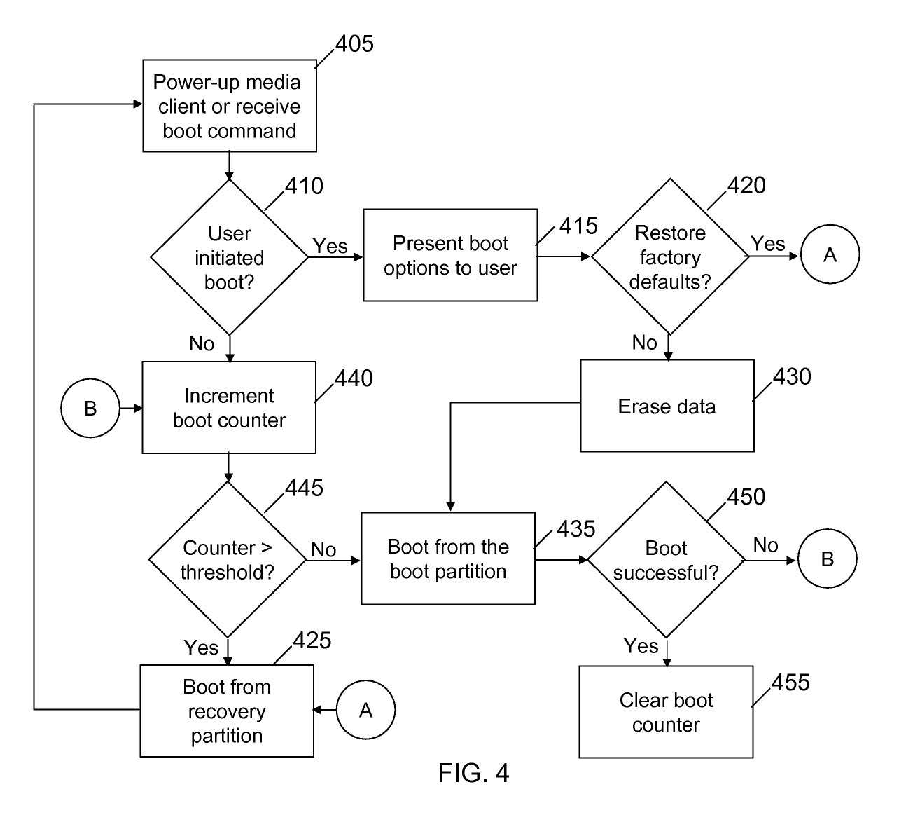

FIG. 4 presents a flowchart for performing a boot operation in the media client 100. When the media client 100 is initially powered up or when a boot command is received from a user, one of a plurality of possible boot sequences can be performed (405). A boot sequence is performed to initialize the media client 100 for operation. Further, the media client 100 can determine whether a user has initiated the boot operation (410). For example, a user can command the media client 100 to execute a boot operation by entering a specific command using a remote control, such as by holding down one or more buttons for a predetermined period of time. Alternatively, the user can enter the command through a touch screen or other input device associated with the media client 100.

If the boot operation is user initiated, one or more options and/or a confirmation request can be presented to the user, such as through a video prompt, an audio prompt, or a combination thereof (415). For example, the user can be asked to specify whether the boot operation should restore all factory default settings in the media client 100 or erase all of the current user settings and media stored on the media client 100. In an implementation, a user also can be permitted to specify that the user initiated boot operation should be executed as a power on boot operation. Additionally, a default boot operation can be selected if the user does not enter a selection indicating a boot operation within a predetermined time period.

The media client 100 can determine which of the presented options has been selected, such as whether the user has selected the boot operation to restore all factory defaults (420). For example, a value indicating the user's selection can be stored in a memory included in the media client 100, such as the non-volatile memory 140 If the user has specified that the factory default settings should be restored, the media client 100 can set a flag in memory to indicate that the user has requested a restore operation and can then execute a boot operation based on the recovery partition 305 (425).

If the user has not selected the option to restore factory defaults, the media client 100 can be configured to perform a procedure, such as by calling a utility, to erase all of the user settings and media stored on the media client 100 (430). For example, the media content stored in the media partition 320 can be deleted or the media partition 320 can be reformatted. Similarly, one or more user settings stored in the boot partition 310 and/or the scratch partition 315 can be deleted or reset to default values. Once the stored user settings and media have been erased, the media client 100 can perform a boot operation from the boot partition (435).

If the media client 100 determines that the boot operation was not user initiated, the media client can increment a boot counter (440). The value associated with the boot counter also can be stored in the non-volatile memory 140. In an implementation, the boot counter also can be incremented during a user initiated boot in which the user selects an option corresponding to a power on boot operation. The value of the boot counter then can be compared with a predetermined threshold value to determine whether the threshold has been exceeded (445). The threshold corresponds to the number of consecutive unsuccessful boot operations that can be executed before the media client 100 initiates a boot recovery operation. For example, the media client 100 can be configured to initiate a boot recovery operation after five consecutive unsuccessful boot operations.

If the value of the boot counter has not exceeded the predetermined threshold, the boot operation can be executed from the boot partition 310 (435). After the boot operation has been completed, the media client 100 can determine whether the boot operation was successful (450). If the boot operation was successful, the value of the boot counter is reset, such as to zero (455). If the boot operation was not successful, the value of the boot counter is incremented (440). Once the value of the boot counter exceeds the predetermined threshold, a boot recovery operation can be executed from the recovery partition 305 (425). Additionally, prior to executing the boot recovery operation, a boot partition identifier can be set to indicate the recovery partition (305). The boot partition identifier can be stored in the non-volatile memory 140.

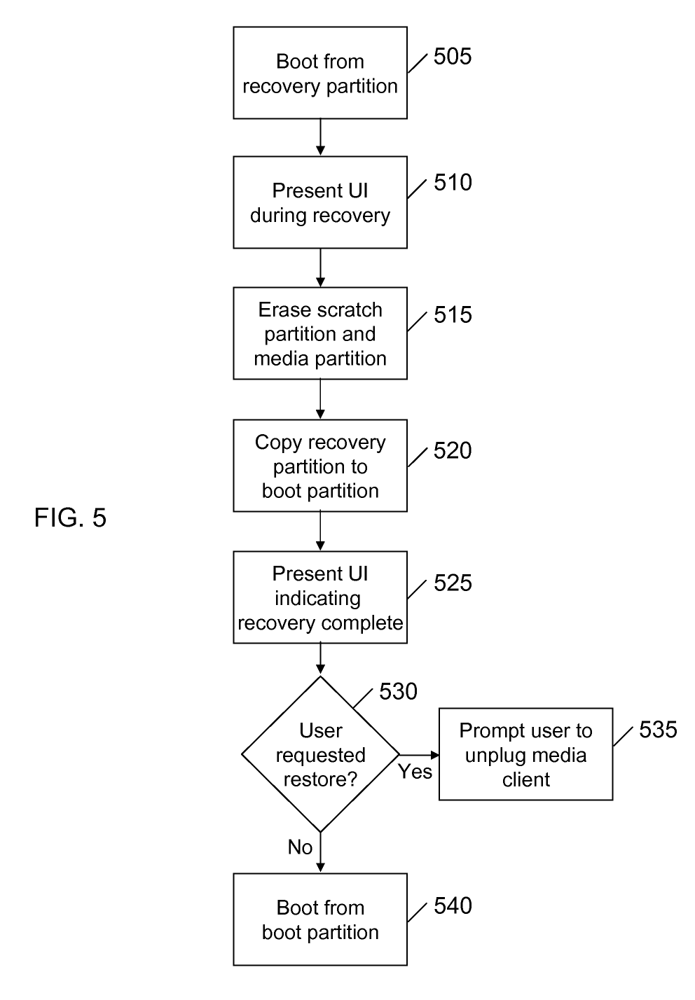

FIG. 5 presents a flowchart for performing a boot recovery operation in the media client 100. Upon initiation of a boot recovery operation, such as in response to a predetermined number of unsuccessful boot attempts or a user command, one or more recovery instructions stored in a recovery partition 305 can be executed to recover the media client 100. A user interface can be presented to inform the user that a boot recovery operation is being performed (510). In an implementation, the user interface can report the status of the boot recovery operation and provide an estimated of the time remaining. The user interface also can include one or more user prompts, including a prompt requesting the user to confirm that a boot recovery operation is to be performed. The user interface, including the prompts, can be presented using audio information, image or video information, or a combination thereof. Further, all of the content stored in the scratch partition 315 and the media partition 320 can be erased (515). For example, the scratch partition 315 and the media partition 320 can be reformatted. Alternatively, all of the data stored in the scratch partition 315 and the media partition 320 can be deleted.

Additionally, at least a portion of the content stored in the recovery partition 305 can be copied to the boot partition 310 (520). In an implementation, information stored in the boot partition 310 can be erased before content from the recovery partition 305 is copied to the boot partition 310, such as by reformatting the boot partition 310 or deleting information stored therein. When the boot recovery process is complete, a user interface can be presented to inform the user (525).

The media client 100 can determine whether the boot recovery operation was executed in response to a user request to restore the factory default settings (530). If the user requested restoration of the factory default settings, the media client 100 can prompt the user to unplug the media client 100 (535). For example, the factory default settings can be restored if the user desires to transfer the media client 100 to a different user. In an implementation, an out-of-the-box initialization process can be executed when the restored media client 100 is first powered on after the factory default settings are restored.

If the boot recovery operation was not executed in response to a user request to restore factory default settings, the media client 100 can be booted from the restored boot partition (540). In an implementation, one or more settings can be defined after the media client 100 has been recovered, including a language preference, a time zone, one or more networking parameters, and a pairing with one or more media servers. Additionally, operating instructions can be available for the media client 100 that are more current than the set of operating instructions stored in the recovery partition 305, such as a new version of operating instructions or one or more patches. Thus, any updates to the set of operating instructions stored in the boot partition 310 can be implemented through update procedures during operation of the media client 100.

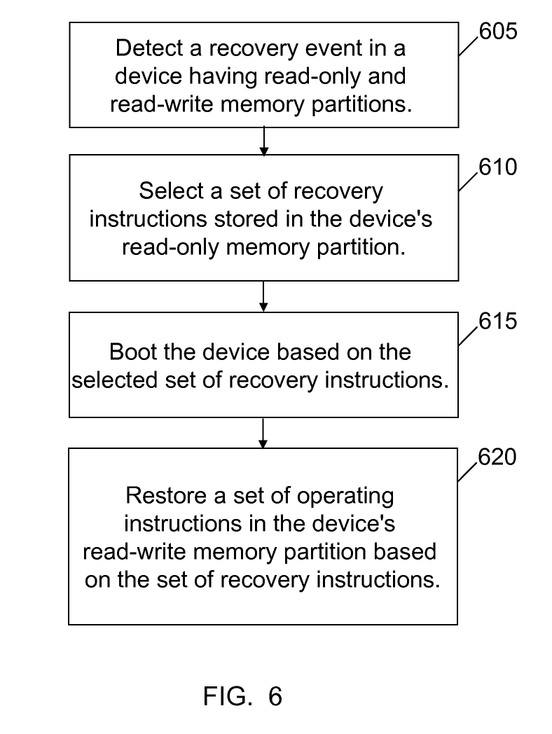

FIG. 6 describes a computer-implemented method of recovering a device. In a first step 605, a recovery event is detected in a device having read-only and read-write memory partitions. In a second step 610, a set of recovery instructions stored in the device's read-only memory partition is selected. In a third step 615, the device is booted based on the selected set of recovery instructions. Once the device has been booted, a fourth step 620 is to restore a set of operating instructions in the device's read-write memory partition based on the set of recovery instructions.

A number of implementations have been disclosed herein. Nevertheless, it will be understood that various modifications may be made without departing from the spirit and scope of the claims. Accordingly, other implementations are within the scope of the following claims.

What is claimed is:

1. A computer-implemented method of recovering a device, the method comprising:
detecting a recovery event in a device having read-only and read-write memory partitions;
selecting a set of recovery instructions stored in the device's read-only memory partition;
booting the device based on the selected set of recovery instructions; and
restoring a set of operating instructions in the device's read-write memory partition based on the set of recovery instructions.

2. The method of claim 1, wherein detecting a recovery event further comprises:
detecting a predetermined number of consecutive unsuccessful boot operations.

3. The method of claim 1, wherein detecting a recovery event further comprises:
receiving from a user a command to execute a recovery operation.

4. The method of claim 1, further comprising:
setting a value in a non-volatile memory to identify the read-only partition storing the set of recovery instructions as a boot partition.

5. The method of claim 1, wherein restoring a set of operating instructions further comprises:
replacing the set of operating instructions with at least a portion of the set of recovery instructions.

6. The method of claim 5, wherein:
the read-write memory partition is formatted prior to replacing the set of operating instructions.

7. The method of claim 1, wherein restoring a set of operating instructions further comprises:
downloading and installing one or more updates from a server.

8. The method of claim 1, further comprising:
booting the device based on the restored set of operating instructions.

9. The method of claim 1, further comprising:
erasing at least one item of information stored on the device, wherein the at least one item of information comprises media content or configuration information.

10. A computer program product, encoded on a computer-readable medium, operable to cause data processing apparatus to perform operations comprising:
detecting a recovery event in a device having read-only and read-write memory partitions;
selecting a set of recovery instructions stored in the device's read-only memory partition;
booting the device based on the selected set of recovery instructions; and
restoring a set of operating instructions in the device's read-write memory partition based on the set of recovery instructions.

11. The computer program product of claim 10, further operable to cause data processing apparatus to perform operations comprising:
detecting a predetermined number of consecutive unsuccessful boot operations.

12. The computer program product of claim 10, further operable to cause data processing apparatus to perform operations comprising:
receiving from a user a command to execute a recovery operation.

13. The computer program product of claim 10, further operable to cause data processing apparatus to perform operations comprising:
setting a value in a non-volatile memory to identify the read-only partition storing the set of recovery instructions as a boot partition.

14. The computer program product of claim 10, further operable to cause data processing apparatus to perform operations comprising:
replacing the set of operating instructions with at least a portion of the set of recovery instructions.

15. The computer program product of claim 14, wherein:
the read-write memory partition is formatted prior to replacing the set of operating instructions.

16. The computer program product of claim 10, further operable to cause data processing apparatus to perform operations comprising:
downloading and installing one or more updates from a server.

17. The computer program product of claim 10, further operable to cause data processing apparatus to perform operations comprising:
booting the device based on the restored set of operating instructions.

18. The computer program product of claim 10, further operable to cause data processing apparatus to perform operations comprising:
erasing at least one item of information stored on the device, wherein the at least one item of information comprises media content or configuration information.
